(19) United States
(12) Patent Application Publication
(10) Pub. No.: US 2003/0040563 A1
(43) Pub. Date: Feb. 27, 2003

(54) Substantially non-abrasive thermally conductive polymer composition containing boron nitride

(76) Inventors: E. Mikhail Sagal, Wakefield, RI (US); Kevin A. McCullough, North Kingstown, RI (US); James Miller, Marietta, GA (US)

Correspondence Address: BARLOW, JOSEPHS & HOLMES, LTD., 101 DYER STREET, 5TH FLOOR, PROVIDENCE, RI, 02903, US

(21) Appl. No.: 10/225,502

(22) Filed: Aug. 22, 2002

Related U.S. Application Data
(60) Provisional application No. 60/314,366, filed on Aug. 23, 2001.

(51) Int. Cl. C08K 3/18; C08K 3/38

(52) U.S. Cl. 524/404; 524/430

(57) ABSTRACT

This invention relates to a thermally conductive molding composition having a thermal conductivity greater than 3 W/m° K. The composition consists essentially of: a) 30% to 60% of a polymer matrix; b) 25% to 60% of boron nitride; and c) 25% to 60% of alumina. The boron nitride and alumina are dispersed throughout the polymer matrix. The composition can be molded or cast into a variety of articles such as packaging materials for semiconductor devices.

### CROSS-REFERENCE TO RELATED APPLICATIONS

This application is related to and claims priority from earlier filed provisional patent application No. 60/314,366, filed Aug. 23, 2001.

### BACKGROUND OF THE INVENTION

The present invention relates generally to an improved thermally conductive polymer composition. Particularly, the present invention relates to a thermally conductive polymer composition containing a polymer matrix with boron nitride and alumina filler materials dispersed therein. The composition can be shaped into a variety of articles such as packaging materials for semiconductor devices.

Polymer compositions comprising a base polymer matrix and thermally conductive fillers are generally known. These compositions can be molded into articles having heat-transfer properties. The articles can be used to dissipate heat from heat-generating devices such as semiconductors, microprocessors, circuit boards, and the like. These electrical devices can generate a tremendous amount of heat that must be removed in order for the device to properly operate. For example, thermally conductive compositions can be molded into packaging materials that will dissipate heat and protect semiconductor devices from heat damage.

Currently, many thermally conductive composite materials are made using only alumina as the thermally conductive filler material. Alumina is a very hard ceramic material having a Knoop hardness in the range of approximately 1700 to 2200. As a result, when alumina is mixed into the base polymer carrier and injection-molded under high pressure at a high rate of speed, it can be highly abrasive. This abrasive action causes excessive wear on tools, injection screws, check rings, and injection barrels. The abrasive nature of alumina can lead to an increase in manufacturing costs. Particularly, a large component to the overall cost of a high volume molding job is often the cost associated with replacing worn-out pieces of molding equipment.

Thermally conductive fillers other than alumina can be used in molding compositions. For example, McCullough, U.S. Pat. Nos. 6,251,978 and 6,048,919 disclose thermally and electrically conductive composite materials that are net-shape moldable. The '978 and '919 Patents disclose compositions containing: a) between 30 to 60% by volume of a polymer base matrix, b) between 25 to 60% by volume of a thermally conductive filler having a relatively high aspect ratio of at least 10:1, and c) between 10 to 25% by volume of a second thermally conductive filler having a relatively low aspect ratio of 5:1 or less. The '978 and '919 Patents disclose that the materials employed for the high aspect and low aspect ratio fillers may be selected from the group consisting of aluminum, alumina, copper, magnesium, brass, and carbon. In addition, the '978 and '919 Patents include an example describing a composition containing 50% by volume of a liquid crystalline polymer; 35% by volume of high aspect ratio PITCH-based carbon flakes with an aspect ratio of approximately 50:1; and 15% by volume of boron nitride granules with an aspect ratio of approximately 4:1.

Hill et al., U.S. Pat. No. 5,681,883 discloses a high thermal conductivity molding composition having a spiral flow of above 10 inches and a thermal conductivity of above 5 W/m° K. comprising a polymer base matrix, a boron nitride filler in a concentration of above 60%, and a non-ionic surfactant selected from the class of carboxylic acid amides and carboxylic acid esters. The non-ionic surfactant is added to the polymer base matrix in an amount above 1%.

It is an object of the present invention to provide a thermally conductive composition that is moldable and substantially non-abrasive. The present invention provides such a composition.

### SUMMARY OF THE INVENTION

The present invention relates to a thermally-conductive composition consisting essentially of: a) 30% to 60% by volume of a polymer matrix, b) 25% to 60% by volume of boron nitride, and c) 25% to 60% by volume of alumina. The boron nitride and alumina filler materials are dispersed throughout the matrix. The composition preferably has a thermal conductivity of greater than 3 W/m° K., and more preferably greater than 22 W/m° K.

Suitable polymers that can be used to form the base matrix include thermoplastic and thermosetting polymers. Liquid crystalline polymers are preferred. Typically, the boron nitride is in the form of a granular powder. The powder grains can have various shapes such as spherical, flake, or hexagonal-like structures. The boron nitride generally has an aspect ratio of 5:1 or less. In one embodiment, the polymer matrix is present in an amount of 50%, and the boron nitride and alumina are each present in an amount of 25%.

### BRIEF DESCRIPTION OF THE DRAWINGS

The novel features that are characteristic of the present invention are set forth in the appended claims. However, the preferred embodiments of the invention, together with further objects and attendant advantages, will be best understood by reference to the following detailed description taken in connection with the accompanying drawing.

FIG. 1 is a cross-section of the thermally conductive composite material of the present invention containing boron nitride and alumina granules dispersed in a polymer matrix.

### DETAILED DESCRIPTION OF THE PREFERRED EMBODIMENT

The polymeric composition of this invention includes a base polymer matrix. Thermoplastic polymers such as polyethylene, acrylics, vinyls, and fluorocarbons can be used to form the polymer matrix. Alternatively, thermosetting polymers such as elastomers, epoxies, polyesters, polyimides, and acrylonitriles can be used as the matrix. Suitable elastomeric materials include polysiloxanes (silicones) and polyurethanes. Liquid crystal polymers are preferred due to their highly crystalline nature and ability to provide a good matrix for the boron nitride and alumina filler materials. The polymer matrix constitutes about 30 to about 60% by volume of the total composition.

In the present invention, boron nitride and alumina are used as the filler materials. As discussed above, many conventional thermally conductive materials are made using only alumina as the filler material. Such compositions are highly abrasive and can cause excessive wear on molding equipment. In accordance with the present invention, it has been found that boron nitride can be used in place of a portion of the alumina to make the composition more lubricious. Boron nitride particles are substantially less abrasive than alumina particles. Particularly, alumina has a Knoop hardness in the range of about 1700 to 2200, while boron nitride has a Knoop hardness of about 11. The boron nitride is present in an amount of about 25 to about 60% by volume of the composition.

Typically, the boron nitride is in the form of a granular powder comprising grains having a relatively low aspect (length to thickness) ratio of 5:1 or less. The grains can have a variety of structures including spherical, flake, or hexagonal-like plate shapes. It is recognized that the boron nitride filler material can have other forms. For example, the boron nitride can be in the form of whiskers or fibers.

The alumina filler material may be in the form of particles, flakes, beads, fibers, or any other suitable shape. The alumina particles can have a relatively high aspect (length to thickness) ratio of 10:1 or greater, or a relatively low aspect ratio of 5:1 or less. Typically, alumina particles are used. The alumina is present in an amount of about 25 to about 60% by volume of the composition.

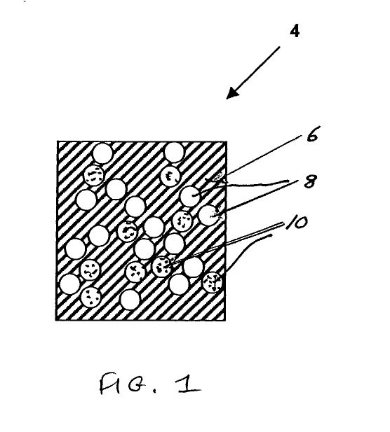

Referring to FIG. 1, a cross-sectional view of composite material 4 shows a base matrix of polymer 6 with boron nitride particles 8 and alumina particles 10 dispersed throughout the matrix. The boron nitride particles 8 and alumina particles 10 penetrate the matrix in a random pattern.

As discussed above, the composition of the present invention includes both boron nitride and alumina. It has been found that boron nitride can be substituted in place of some of the alumina to form a composition containing both boron nitride and alumina, and there is no detrimental effect on the composition's thermal conductivity. In fact, thermal conductivity typically improves, since boron nitride is more thermally conductive than alumina. For instance, boron nitride can independently have a thermal conductivity of approximately 400 W/m° K. Preferably, the boron nitride improves the overall thermal conductivity of the composite so that the composite has a thermal conductivity of greater than 3 W/m° K. More preferably, the composite has a thermal conductivity of greater than 22 W/m° K.

In general, the composition of the present invention consists essentially of 30 to 60% polymer matrix, 25 to 60% boron nitride, and 25% to 60% alumina. In one embodiment, the composition consists essentially of 50% polymer matrix, 25% boron nitride, and 25% alumina. It is not necessary to add other fillers such as carbon fiber or other high aspect ratio materials to the composition of this invention. Nevertheless, the composition may contain minor amounts of additives, if desired, so long as such ingredients do not affect the basic nature and properties of the composition. If such ingredients are added, they should be added in an amount less than 1% by volume of the composition. For example, antioxidants, plasticizers, non-conductive fillers, stabilizers, and dispersing agents can be added to the composition.

The boron nitride and alumina are intimately mixed with the non-conductive polymer matrix. The loading of the boron nitride and alumina in the matrix imparts thermal conductivity to the composition. The mixture can be prepared and shaped into a thermally conductive article using techniques known in the industry. The ingredients are preferably mixed under low shear conditions in order to avoid damaging the boron nitride and alumina granules. The composition may be shaped into various articles such as packaging materials or elastomeric pads using any suitable process such as melt-extrusion, casting, or injection-molding.

During a molding process, the composite mixture is injected into a mold cavity. The mold may have a complex shape with varying dimensions and angles along its edges. It is important that the molten polymer composition have good flow properties so that it can flow completely into the mold and form the desired geometry of the article. In some conventional molding compositions, boron nitride filler material is added to the polymer matrix at loadings greater than 60%, but such high loadings can substantially inhibit flow properties. Further, at such high loadings, the base polymer may not “wet-out” causing undesirable small air products in the finished molded product. In contrast, the composition of the present invention contains no greater than 60% boron nitride filler and has generally good flow properties.

In the present invention, the boron nitride acts as a flow additive enhancing the flow of the composite mixture through the molding machine. As the composition is molded, the more lubricious boron nitride tends to “wet-out” and contacts the surface of the mold tooling. In contrast, the more abrasive alumina tends to remain in the center of the molding composition and does not strike the surface of the mold tooling. Thus, the substantially non-abrasive compositions of this invention can be molded into articles without causing excessive wear and tear on the mold tooling.

The shaped articles produced from the compositions of this invention are thermally conductive. Preferably, the shaped article has a thermal conductivity of greater than 3 W/m° K., and more preferably greater than 22 W/m° K. These articles can be used to dissipate heat from heat-generating devices such as semiconductors, microprocessors, circuit boards, and the like.

It is appreciated by those skilled in the art that various changes and modifications can be made to the illustrated embodiments without departing from the spirit of the present invention. All such modifications and changes are intended to be covered by the appended claims.

What is claimed is:

1. A thermally-conductive molding composition consisting essentially of: a) 30% to 60% by volume of a polymer matrix, b) 25% to 60% by volume of boron nitride, and c) 25% to 60% by volume of alumina, wherein the boron nitride and alumina are dispersed throughout the polymer matrix and the composition has a thermal conductivity greater than 3 W/m° K.

2. The molding composition of claim 1, wherein the polymer matrix comprises a liquid crystal polymer.

3. The molding composition of claim 1, wherein the polymer matrix comprises a thermoplastic or thermosetting polymer.

4. The molding composition of claim 1, wherein the boron nitride is in the form of a granular powder.

5. The molding composition of claim 4, wherein the boron nitride granular powder comprises grains having a spherical-like structure.

6. The molding composition of claim 4, wherein the boron nitride granular powder comprises grains having a hexagonal-like structure.

7. The molding composition of claim 1, wherein the boron nitride and alumina each has an aspect ratio of 5:1 or less.

8. The molding composition of claim 1, wherein the boron nitride has an aspect ratio of 5:1 or less, and the alumina has an aspect ratio of 10:1 or greater.

10. The molding composition of claim 1, wherein the composition has a thermal conductivity greater than 22 W/m° K.

11. A thermally-conductive molding composition consisting essentially of: a) 50% by volume of a polymer matrix, b) 25% by volume of boron nitride, and c) 25% by volume of alumina, wherein the boron nitride and alumina are dispersed throughout the polymer matrix and the composition has a thermal conductivity greater than 3 W/m° K.

12. The molding composition of claim 11, wherein the composition has a thermal conductivity greater than 22 W/m° K.
